(19) United States
(12) Patent Application Publication
(10) Pub. No.: US 2007/0166033 A1
(43) Pub. Date: Jul. 19, 2007

(54) Analyzing the quality of an optical waveform

(75) Inventor: Cechan Tian, Plano, TX (US)

Correspondence Address: BAKER BOTTS L.L.P., 2001 ROSS AVENUE, SUITE 600, DALLAS, TX, 75201-2980, US

(73) Assignee: Fujitsu Limited

(21) Appl. No.: 11/328,696

(22) Filed: Jan. 10, 2006

(51) Int. Cl. H04B 10/08; H04B 17/00

(52) U.S. Cl. 398/38

(57) ABSTRACT

Monitoring an optical signal includes receiving the optical signal. The optical signal is filtered to pass through a selected wavelength of the optical signal. The following is performed for each selected wavelength: receiving photons of the optical signal at a photo-reactive material operable to produce a reaction in response to the arrival of a predetermined number of photons; producing reactions in response to the arrival of the photons; and generating waveform monitor output in response to the reactions, where the waveform monitor output indicates a waveform quality of the optical signal at each wavelength.

### TECHNICAL FIELD

This invention relates generally to the field of optical networks and more specifically to analyzing the quality of an optical waveform.

### BACKGROUND

A communication network may communicate information using optical signals transmitted as light pulses. The signals may be monitored as they travel through the network. Known techniques for monitoring signals may involve monitoring signal power, signal-to-noise ratio, or signal wavelength. In certain cases, however, these signal features may not provide satisfactory information. Accordingly, these known techniques are not satisfactory in certain situations.

### SUMMARY OF THE DISCLOSURE

In accordance with the present invention, disadvantages and problems associated with previous techniques for monitoring optical signals may be reduced or eliminated.

According to one embodiment of the present invention, monitoring an optical signal includes receiving the optical signal. The optical signal is filtered to pass through a selected wavelength of the optical signal. The following is performed for each selected wavelength: receiving photons of the optical signal at a photo-reactive material operable to produce a reaction in response to the arrival of a predetermined number of photons; producing reactions in response to the arrival of the photons; and generating waveform monitor output in response to the reactions, where the waveform monitor output indicates a waveform quality of the optical signal at each wavelength.

According to another embodiment, the optical power at selected wavelengths may be estimated. The waveform quality at the selected wavelengths may be normalized in accordance with the optical power at the wavelengths.

Certain embodiments of the invention may provide one or more technical advantages. A technical advantage of one embodiment may be that the waveform of a signal may be monitored to establish the waveform quality of the signal. The waveform may be monitored using a photo-reactive material that produces a reaction in response to photons of the signal. The signal waveform may be monitored for various wavelengths of the signal in order to establish the waveform quality of the signal.

Another technical advantage of one embodiment may be that the optical power of the optical signal may be monitored at various wavelengths of the optical signal. The optical power may be used to normalize the measurements of the waveform.

Another technical advantage of one embodiment may be that a tunable filter may be used to selectively scan through the various wavelengths of an optical signal. The optical signal at particular wavelengths may be sent to the waveform monitor to determine the waveform at the wavelength.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram illustrating one embodiment of a network that includes a node that may use photon absorption techniques to analyze signal quality;

FIG. 2 is a block diagram illustrating one embodiment of a waveform analyzer that includes a waveform monitor operable to monitor waveform quality using photon absorption techniques;

FIG. 3 is a block diagram illustrating one embodiment of a waveform monitor that may be used with the waveform analyzer of FIG. 2; and

FIG. 4 is a graph illustrating an example waveform monitor signal.

### DETAILED DESCRIPTION OF THE DRAWINGS

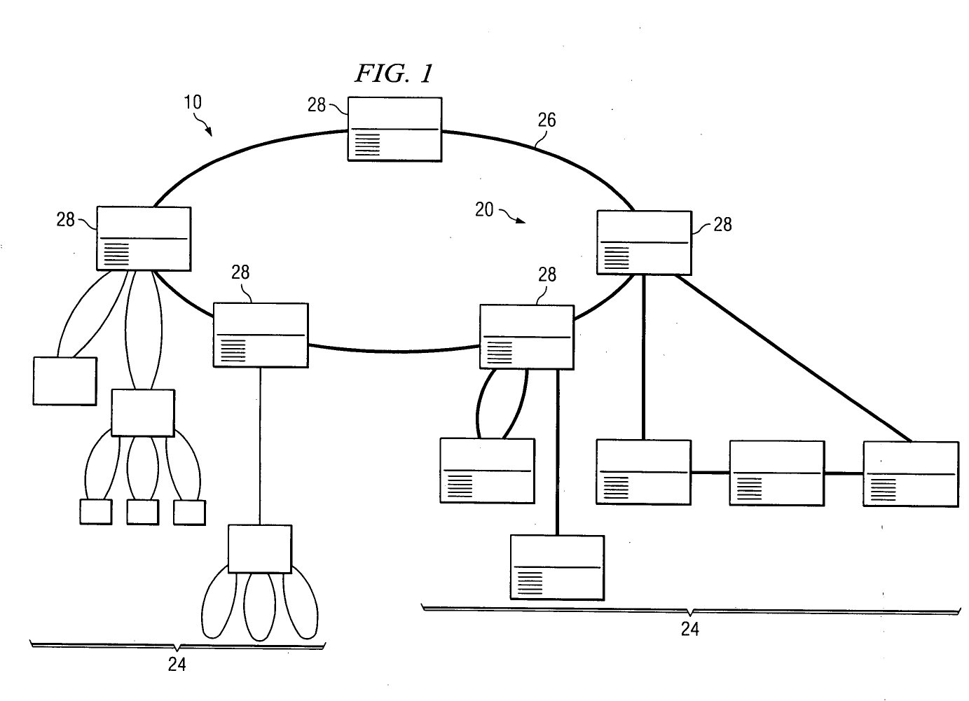

Embodiments of the present invention and its advantages are best understood by referring to FIGS. 1 through 4 of the drawings, like numerals being used for like and corresponding parts of the various drawings.

FIG. 1 is a block diagram illustrating one embodiment of a network 10 that includes a node that may use photon absorption techniques to analyze signal quality. According to the embodiment, the waveform may be monitored using a photo-reactive material that produces a reaction in response to photons of the signal. The signal waveform may be monitored for various wavelengths of the signal in order to establish the waveform quality of the signal.

According to the illustrated embodiment, network 10 communicates using signals. A signal may refer to an optical signal transmitted as light pulses comprising photons. An optical signal may have a frequency of approximately 1550 nanometers, and a data rate of, for example, 10, 20, 40, or over 40 gigabits per second. A signal may be modulated according to any suitable modulation technique, such as a no return-to-zero (NRZ), return-to-zero (RZ), carrier suppressed return-to-zero (CS-RZ), CS-RZ differential phase shifted keying (DPSK), an on/off keying (OOK), or other modulation technique. A signal typically includes one or more components, where a component refers to a portion of light having a specific wavelength or wavelength range.

A signal may communicate information in packets. A packet may comprise a bundle of data organized in a specific way for transmission, and a frame may comprise the payload of one or more packets organized in a specific way for transmission. A packet may carry any suitable information such as voice, data, audio, video, multimedia, other information, or any combination of the preceding. The packets may comprise any suitable multiplexed packets, such time division multiplexed (TDM) packets, communicated using any suitable protocol such as the Ethernet over Synchronous Optical Network (SONET) protocol.

Network 10 includes a ring 20 coupled to access equipment 24 as shown. A ring may refer to a network of communication devices that has a ring topology. According to one embodiment, ring 20 may comprise an optical fiber ring. For example, ring 20 may comprise a resilient packet ring (RPR).

Ring 20 has nodes 28 coupled by fibers 26. A node may refer to a point of a ring at which packets may be communicated to another node. A node 28 may include a waveform analyzer that analyzes the quality of an optical waveform. Fibers 26 may refer to any suitable fiber operable to transmit a signal. According to one embodiment, a fiber 26 may represent an optical fiber. An optical fiber typically comprises a cable made of silica glass or plastic. The cable may have an outer cladding material around an inner core. The inner core may have a slightly higher index of refraction than the outer cladding material. The refractive characteristics of the fiber operate to retain a light signal inside of the fiber.

Access equipment 24 may include any suitable device operable to communicate with nodes 28 of ring 20. Examples of access equipment 24 include access gateways, endpoints, softswitch servers, trunk gateways, networks, access service providers, Internet service providers, or other device operable to communicate with nodes 28 of ring 20.

Modifications, additions, or omissions may be made to network 10 without departing from the scope of the invention. The components of network 10 may be integrated or separated according to particular needs. Moreover, the operations of network 10 may be performed by more, fewer, or other devices. Additionally, operations of network 10 may be performed using any suitable logic. Logic may refer to hardware, software, or any combination of hardware and software. As used in this document, “each” refers to each member of a set or each member of a subset of a set.

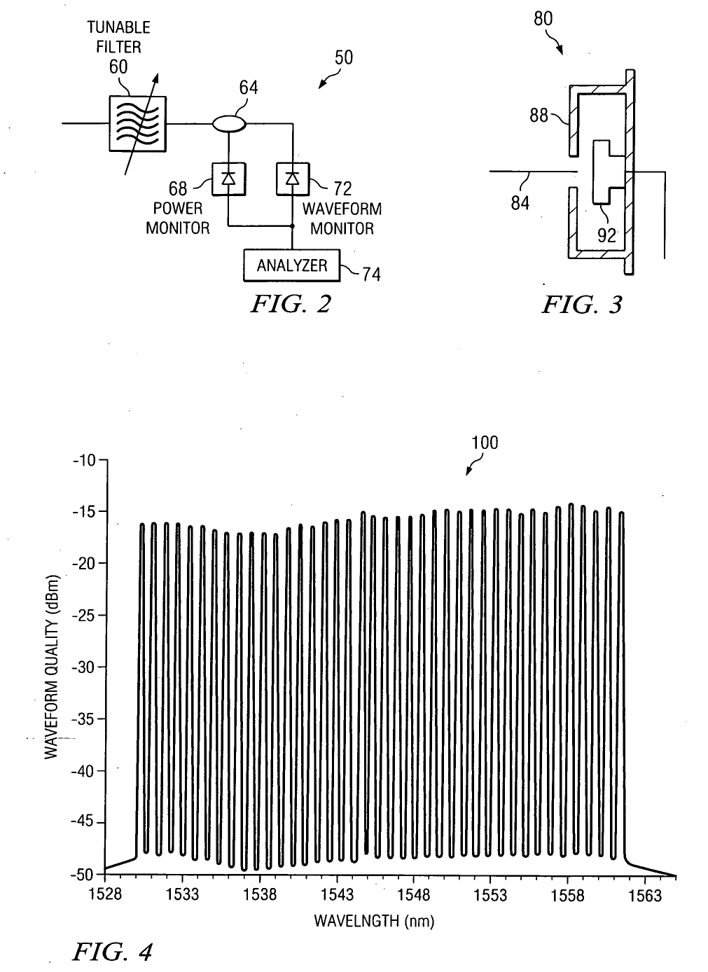

FIG. 2 is a block diagram illustrating one embodiment of a waveform analyzer 50 that includes a waveform monitor operable to monitor waveform quality using photon absorption techniques. Waveform analyzer 50 may be used with network 10 of FIG. 1. According to the embodiment, the waveform may be monitored using a photo-reactive material that produces a reaction in response to photons of the signal. The signal waveform may be monitored for various wavelengths of the signal in order to establish the waveform quality of the signal.

According to the illustrated embodiment, waveform analyzer 50 includes a tunable filter 60, a splitter 64, a power monitor 68, a waveform monitor 72, and an analyzer 74 coupled as shown. According to one embodiment of operation, tunable filter 60 receives an input signal and selects different wavelengths of the signal for analysis. Splitter 64 splits the signal into a first signal for power monitor 68 and a second signal for waveform monitor 72. Power monitor 68 measures the power of the first signal, and waveform monitor 72 measures the waveform of the second signal. Analyzer 79 analyzes the waveform quality of the input signal from the measurements.

According to one embodiment, tunable filter 60 comprises a filter operable to pass through selected wavelengths of an input signal. Tunable filter 60 may scan through wavelengths at any suitable increment. For example, a range of wavelengths from 1,528 nanometers to 1,570 nanometers may be scanned at increments of approximately one nanometer. Any other suitable range, however, may be scanned at any other suitable increment.

Splitter 64 splits the signal into multiple signals. According to the illustrated embodiment, splitter 64 splits the signal into a first signal and a second signal. The first signal is directed towards power monitor 68, and the second signal is directed towards waveform monitor 72.

Power monitor 68 monitors the optical power of the first signal. According to one embodiment, power monitor 68 may comprise a photodiode that detects optical power and generates a power monitor output, such as an electrical signal, that indicates the optical power. A larger output may indicate greater optical power, and a smaller output may indicate smaller optical power.

Waveform monitor 72 detects the waveform of the second signal. According to one embodiment, waveform monitor 72 may comprise a quadric detector that generates a waveform monitor output, such as an electrical signal, that indicates the waveform of a signal. According to one embodiment, the intensity of the electrical signal is proportional to the efficiency of the quadric detection, which is determined by signal quality. Accordingly, greater intensity may indicate a higher signal quality, and smaller intensity may indicate a lower signal quality.

Analyzer 74 receives the power monitor output from power monitor 68 and the waveform monitor output from waveform monitor 72, and analyzes the quality of the input signal according to the output. Signal quality may be affected by, for example, distortion caused by chromatic dispersion. According to one embodiment, analyzer 74 may normalize the waveform monitor output at each wavelength according to the power monitor output at each wavelength. The waveform monitor output may be normalized to compensate for waveform monitor output due to optical power instead of to signal quality.

Analyzer 74 may assess the signal quality in any suitable manner. According to one embodiment, the quality may be assessed from the relative signal intensity of the normalized waveform monitor output. A higher normalized output may indicate a better waveform quality and a lower normalized output may indicate a worse waveform quality.

Modifications, additions, or omissions may be made to waveform analyzer 50 without departing from the scope of the invention. The components of waveform analyzer 50 may be integrated or separated according to particular needs. Moreover, the operations of waveform analyzer 50 may be performed by more, fewer, or other devices. Additionally, operations of network 10 may be performed using any suitable logic.

FIG. 3 is a block diagram of one embodiment of a waveform monitor 80 that is operable to monitor waveform quality using photon absorption techniques. Waveform monitor 80 may be used with waveform analyzer 50 of FIG. 2. Waveform monitor 80 may monitor a waveform using a photo-reactive material that produces a reaction in response to photons of the signal.

According to the illustrated embodiment, waveform monitor 80 includes a fiber 84 and a waveform detector 88 with photon reactive material 92 arranged as shown. Fiber 84 may comprise a tapered optical fiber operable to focus a signal towards photon reactive material 92.

Photon reactive material 92 may comprise material that may produce a reaction when a predetermined number of photons arrive at the material. For example, the material may release an electron when a predetermined number of photons, such as two photons, arrive at substantially the same time at substantially the same place of the material. Substantially the same place may refer to the area in which the number of photons may arrive to produce the reaction. Substantially the same time may refer to the time period in which the number of photons may arrive to produce the reaction. More photons arriving at material 92 increases the probability that the predetermined number of photons arrive at substantially the same time, thus increasing the number of reactions.

Photon reactive material 92 may be used to monitor the waveform of the optical signal. A pulse with a narrower waveform shape may include more photons that arrive at material 92 at the same time, and a pulse with a wider waveform shape may include fewer photons that arrive at material 92 at the same time. Since a pulse with a narrower waveform includes more photons that arrive at material 92 at the same time, a narrower waveform pulse may generate more reactions than a wider waveform pulse. Accordingly, the reactions may comprise feedback that indicates the waveform of the signal.

Material 92 may be selected to respond to a predetermined number of photons. According to one embodiment, material 92 may be selected such that the band gap energy E_{g} of material 92 may react to a number n of photons having photon energy hν. To detect n photons, a material with a band gap energy E_{g} may be selected according to (n-1)hν≦E_{g}≦nhν. For example, a material with an energy E_{g} may be selected according to hν≦E_{g}≦2 hν.

According to one embodiment, detector 88 may comprise a quadric detector such as a silicon avalanche photodiode (APD). A silicon avalanche photodiode comprises a semiconductor material such as silicon. Silicon may release an electron when two photons arrive at substantially the same time at substantially the same place. That is, two photons may generate one electron-hole pair. The photon current is proportional to the square of the input power.

Waveform monitor 80 generates waveform monitor output, such as an electrical signal, in response to the reactions occurring at detector 88. The waveform monitor output reflects waveform quality. An example signal is described with reference to FIG. 4.

Modifications, additions, or omissions may be made to waveform monitor 80 without departing from the scope of the invention. The components of waveform monitor 80 may be integrated or separated according to particular needs. Moreover, the operations of waveform monitor 80 may be performed by more, fewer, or other components.

FIG. 4 is a graph illustrating an example detector signal 100. Detector signal 100 indicates the waveform quality of a signal in a wavelength range of approximately 1,529 nanometers to 1,561 nanometers. The waveform quality is given for wavelengths at increments of approximately one nanometer. The waveform quality may be assessed from signal 100 in any suitable manner. According to one embodiment, the quality may be assessed from the signal intensity at each wavelength.

Signal 100 is presented as an example. Modifications, additions, or omissions may be made to signal 100 without departing from the scope of the invention.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure, as defined by the following claims.

What is claimed is:

1. A signal quality analyzer operable to monitor an optical signal, comprising:
a tunable filter operable to:
receive an optical signal; and
filter the optical signal to pass through a selected wavelength of a plurality of selected wavelengths of the optical signal; and
a waveform monitor comprising a photo-reactive material operable to produce a reaction in response to the arrival of a predetermined number of photons, the waveform monitor operable to perform the following for each selected wavelength of the plurality of selected wavelengths:
receive a plurality of photons of the optical signal;
produce a plurality of reactions in response to the arrival of the plurality of photons; and
generate waveform monitor output in response to the plurality of reactions, the waveform monitor output indicating a waveform quality of the optical signal at the each wavelength.

2. The signal quality analyzer of claim 1, further comprising a power monitor operable to perform the following for the each selected wavelength of the plurality of selected wavelengths:
receive the optical signal; and
generate power monitor output indicating an optical power of the optical signal at the each selected wavelength.

3. The signal quality analyzer of claim 1, further comprising an analyzer operable to:
establish a waveform quality of the optical signal in accordance with the waveform qualities of the optical signal at the plurality of wavelengths.

4. The signal quality analyzer of claim 1, further comprising an analyzer operable to:
estimate an optical power of the optical signal at the each selected wavelength; and
normalize the waveform quality at the each selected wavelength in accordance with the optical power at the each selected wavelength.

5. The signal quality analyzer of claim 1, further comprising an analyzer operable to:
determine the waveform qualities of the optical signal at the plurality of wavelengths with each other; and
establish a waveform quality of the optical signal in accordance with the determination.

6. The signal quality analyzer of claim 1, further comprising a splitter operable to:
receive the optical signal from the tunable filter;
split the optical signal into a first optical signal and a second optical signal;
send the first optical signal to the waveform monitor; and
send the second optical signal to a power monitor.

7. The signal quality analyzer of claim 1, wherein the photo-reactive material comprises a material operable to release an electron when two photons arrive at substantially the same time at substantially the same place of the material.

8. The signal quality analyzer of claim 1, wherein the photo-reactive material comprises silicon.

9. A method for monitoring an optical signal, comprising:
receiving an optical signal;
filtering the optical signal to pass through a selected wavelength of a plurality of selected wavelengths of the optical signal; and
performing the following for each selected wavelength of the plurality of selected wavelengths:
receiving a plurality of photons of the optical signal at a photo-reactive material, the photo-reactive material operable to produce a reaction in response to the arrival of a predetermined number of photons;
producing a plurality of reactions in response to the arrival of the plurality of photons; and
generating waveform monitor output in response to the plurality of reactions, the waveform monitor output indicating a waveform quality of the optical signal at the each wavelength.

10. The method of claim 9, further comprising a power monitor operable to perform the following for the each selected wavelength of the plurality of selected wavelengths:
receive the optical signal; and
generate power monitor output indicating an optical power of the optical signal at the each selected wavelength.

11. The method of claim 9, further comprising:
establishing a waveform quality of the optical signal in accordance with the waveform qualities of the optical signal at the plurality of wavelengths.

12. The method of claim 9, further comprising:
estimating an optical power of the optical signal at the each selected wavelength; and
normalizing the waveform quality at the each selected wavelength in accordance with the optical power at the each selected wavelength.

13. The method of claim 9, further comprising:
determining the waveform qualities of the optical signal at the plurality of wavelengths with each other; and
establishing a waveform quality of the optical signal in accordance with the determination.

14. The method of claim 9, further comprising:
splitting the optical signal into a first optical signal and a second optical signal;
sending the first optical signal to a waveform monitor; and
sending the second optical signal to a power monitor.

15. The method of claim 9, wherein the photo-reactive material comprises a material operable to release an electron when two photons arrive at substantially the same time at substantially the same place of the material.

16. The method of claim 9, wherein the photo-reactive material comprises silicon.

17. A signal quality analyzer operable to monitor an optical signal, comprising:
a tunable filter operable to:
receive an optical signal; and
filter the optical signal to pass through a selected wavelength of a plurality of selected wavelengths of the optical signal;
a waveform monitor comprising a photo-reactive material operable to produce a reaction in response to the arrival of a predetermined number of photons, the waveform monitor operable to perform the following for each selected wavelength of the plurality of selected wavelengths:
receive a plurality of photons of the optical signal;
produce a plurality of reactions in response to the arrival of the plurality of photons; and
generate waveform monitor output in response to the plurality of reactions, the waveform monitor output indicating a waveform quality of the optical signal at the each wavelength; and
an analyzer operable to:
establish a waveform quality of the optical signal in accordance with the waveform qualities of the optical signal at the plurality of wavelengths.

18. The signal quality analyzer of claim 17, further comprising a power monitor operable to perform the following for the each selected wavelength of the plurality of selected wavelengths:
receive the optical signal; and
generate power monitor output indicating an optical power of the optical signal at the each selected wavelength.

19. A system for monitoring an optical signal, comprising:
means for receiving an optical signal;
means for filtering the optical signal to pass through a selected wavelength of a plurality of selected wavelengths of the optical signal; and
means for performing the following for each selected wavelength of the plurality of selected wavelengths:
receiving a plurality of photons of the optical signal at a photo-reactive material, the photo-reactive material operable to produce a reaction in response to the arrival of a predetermined number of photons;
producing a plurality of reactions in response to the arrival of the plurality of photons; and
generating waveform monitor output in response to the plurality of reactions, the waveform monitor output indicating a waveform quality of the optical signal at the each wavelength.

20. A signal quality analyzer operable to monitor an optical signal, comprising:
a tunable filter operable to:
receive an optical signal; and
filter the optical signal to pass through a selected wavelength of a plurality of selected wavelengths of the optical signal;
a splitter operable to:
receive the optical signal from the tunable filter;
split the optical signal into a first optical signal and a second optical signal;
send the first optical signal to a waveform monitor; and
send the second optical signal to a power monitor;
the waveform monitor comprising a photo-reactive material operable to produce a reaction in response to the arrival of a predetermined number of photons, the photo-reactive material comprising a material operable to release an electron when two photons arrive at substantially the same time at substantially the same place of the material, the photo-reactive material comprising silicon, the waveform monitor operable to perform the following for each selected wavelength of the plurality of selected wavelengths:
receive a plurality of photons of the optical signal;
produce a plurality of reactions in response to the arrival of the plurality of photons; and
generate waveform monitor output in response to the plurality of reactions, the waveform monitor output indicating a waveform quality of the optical signal at the each wavelength;
the power monitor operable to perform the following for the each selected wavelength of the plurality of selected wavelengths:
receive the optical signal; and
generate power monitor output indicating an optical power of the optical signal at the each selected wavelength; and
an analyzer operable to establish a waveform quality of the optical signal in accordance with the waveform qualities of the optical signal at the plurality of wavelengths by performing the following:
estimate an optical power of the optical signal at the each selected wavelength;
normalize the waveform quality at the each selected wavelength in accordance with the optical power at the each selected wavelength;
determine the waveform qualities of the optical signal at the plurality of wavelengths with each other; and
establish a waveform quality of the optical signal in accordance with the determination.
